(19) United States
(12) Patent Application Publication
(10) Pub. No.: US 2022/0381997 A1
(43) Pub. Date: Dec. 1, 2022

(54) Fibre Optic Connector

(71) Applicant: Ridgemount Technologies Limited, Bicester Oxfordshire (GB)

(72) Inventors: Mark Limbert, Bicester Oxfordshire (GB); Christopher Peters, Launton, Bicester Oxfordshire (GB)

(21) Appl. No.: 17/765,283

(22) PCT Filed: Jul. 30, 2020
(86) PCT No.: PCT/GB2020/051826

§ 371 Date: Mar. 30, 2022

(30) Foreign Application Priority Data
Nov. 28, 2019 (GB) 1917373.1

(51) Int. Cl. G02B 6/38

(52) U.S. Cl. CPC G02B 6/3831; G02B 6/3825

(57) ABSTRACT

There is described a fibre optic connector for insertion to a fibre optic adaptor, the fibre optic connector comprising a body portion and a latch mechanism provided on the body. The latch mechanism comprises at least one resiliently deformable latch member and the resiliently deformable latch member comprises at least one engagement element. The at least one engagement element comprises a leading surface and a trailing surface, wherein the angle between said trailing surface and said at least one resiliently deformable latch member is obtuse.

### FIELD OF THE INVENTION

The present invention relates to a fibre optic connector. The invention also relates to a kit of parts comprising a fibre optic adaptor and a fibre optic connector.

### BACKGROUND TO THE INVENTION

Fibre optic connections, such as patch cords and interconnects, are known to be made with a standard LC (Lucent Technology) Connector. Such fibre optic connectors receive and terminate optical fibres. In use, LC connectors are releasably inserted into LC adaptors and are not subjected to repeated mating i.e. repeated insertion and removal of the connector into the adaptor. As such, conventional LC connectors are designed to lock in place once inserted into the adaptor, commonly using a latch mechanism.

The conventional LC Connector interface, as defined in IEC 61754-20, comprises a latch operating in a vertical plane. In use, the user actuates the connector by depressing the connector latch in a direction vertically towards the body to disengage the connector from a corresponding adaptor. Vertical action depressing of the latch is required to facilitate removal and disconnection of the fibre optic connector from the adaptor, and as such the latch locks the connector in place during use.

In instances where loads are applied to the connector-fibre optic assembly, such as accidental loads, this often causes failure as the connector is locked and unable to easily disengage from the adaptor. There are two primary modes of failure. The first is the fibre optic connector pulling away from the optical fibres, which occurs when the applied load is greater than the specified strain relief of the connector assembly. The second is permanent deformation, or catastrophic failure, of the connector latch. In both of these scenarios it is necessary to replace and re-install a new connector or connector-fibre optic assembly.

Objects and aspects of the present claimed invention seek to alleviate at least these problems with the prior art.

### SUMMARY OF THE INVENTION

According to a first aspect of the invention, there is provided a fibre optic connector for insertion to a fibre optic adaptor. Here, the fibre optic connector comprises a body portion and a latch mechanism provided on the body, the latch mechanism comprising at least one resiliently deformable latch member. The resiliently deformable latch member comprises at least one engagement element and the at least one engagement element comprises a leading surface and a trailing surface, wherein the angle between the trailing surface and the resiliently deformable latch member is obtuse.

In this way, a fibre optic connector which facilitates removal of the fibre optic connector from a fibre optic adaptor is provided without user actuation of the latch mechanism. In this way, a reduction in the risk of failure or deformation of the fibre optic connector when received in a fibre optic adaptor is achieved when the fibre optic connector is subject to accidental or deliberate forces in a direction longitudinal to the fibre optic connector.

Preferably, the angle between the trailing surface and the resiliently deformable latch member is between 100° and 170°. More preferably, the angle between the trailing surface and the resiliently deformable latch member is between 110° and 160°. Still more preferably, the angle between the trailing surface and the resiliently deformable latch member is between 120° and 150°. Most preferably, the angle between the trailing surface and the resiliently deformable latch member is between 126° and 144°.

Preferably, at least one resiliently deformable latch member is configured to resiliently deform in a direction perpendicular to the longitudinal axis of the fibre optic connector. More preferably, all resiliently deformable latch member is configured to resiliently deform in a direction perpendicular to the longitudinal axis of the fibre optic connector

Preferably, the latch mechanism comprises two resiliently deformable latch members.

Preferably, the resiliently deformable latch members are mirror images of one another. Preferably, the resiliently deformable latch members are mounted substantially opposite one another. Preferably, the resiliently deformable latch members are configured to deform towards each other in use.

Preferably, the resiliently deformable latch members are resiliently biased away from one another. Alternatively, the at least one resiliently deformable member is resiliently biased in a direction away from the body portion.

Preferably, in use, a minimum removal force of between 5N and 40N is required to overcome the resilient bias to remove the fibre optic connector from a fibre optic adaptor. More preferably, in use, a minimum removal force of between 15N and 30N is required to overcome the resilient bias to remove the fibre optic connector from a fibre optic adaptor. Most preferably, in use, a removal force of 20N is required to overcome the resilient bias to remove the fibre optic connector from a fibre optic adaptor.

Preferably, the trailing surface comprises a curve More preferably, the trailing surface comprises a convex curve. Preferably, the leading surface comprises a curve. More preferably, the leading surface comprises a convex curve. Preferably, the curve is a continuous curve.

Preferably, the leading surface and the trailing surface are substantially mirror images of one another. Preferably, the engagement element comprises a spherical cap. More preferably, the engagement element comprises a hemisphere.

Preferably, the resiliently deformable latch member transitions smoothly into the engagement element. More preferably, the resiliently deformable latch member transitions smoothly into the leading surface. Even more preferably, the resiliently deformable latch member transitions smoothly into the trailing surface. Most preferably, the resiliently deformable latch member transitions smoothly into the leading surface and into the trailing surface.

Alternatively, there is a defined edge where the trailing surface meets the resiliently deformable latch member.

Preferably, the at least one resiliently deformable latch member is configured to resiliently deform towards the body portion. More preferably, at least one resiliently deformable latch member is configured to resiliently deform in a direction parallel to a surface of the body portion.

Preferably, the at least one resiliently deformable latch member comprises a release portion. More preferably, the release portion is located at the end of the resiliently deformable latch member distal from the body portion.

Preferably, the at least one resiliently deformable latch member protrudes beyond an edge of the body portion.

Preferably, the fibre optic connector comprises at least two latch mechanisms. More preferably, the latch mechanisms are provided on opposing faces of the body portion.

Preferably, the number of resiliently deformable latch members and the number of the engagement elements is equal.

According to a second aspect of the invention, there is provided a kit of parts comprising a fibre optic adaptor and the fibre optic connector as described above.

### DETAILED DESCRIPTION

Embodiments of the present invention will now be described by way of example only and with reference to the accompanying drawings, in which:

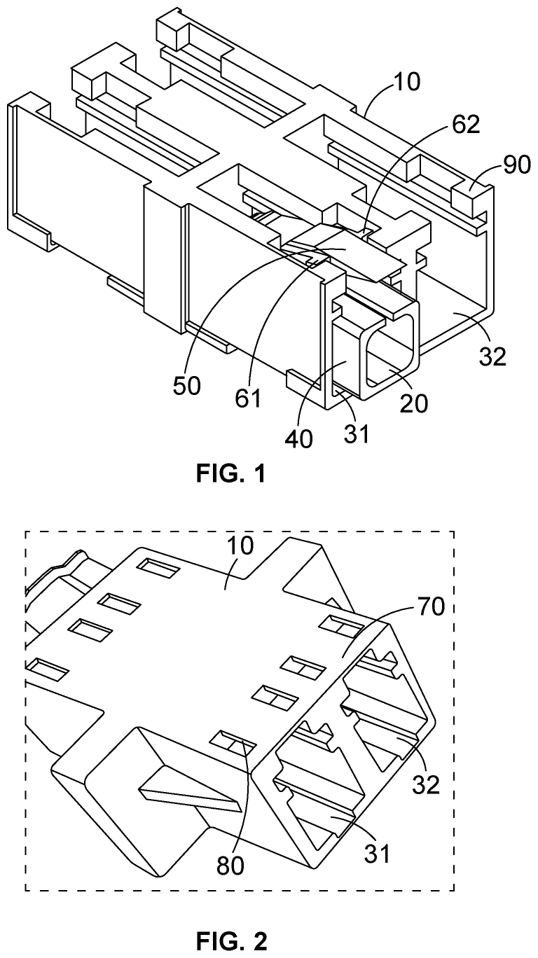

FIG. 1 depicts a deconstructed view of a typical fibre optic adaptor into which a prior art simplex fibre optic connector is inserted;

FIG. 2 depicts a perspective view of a prior art fibre optic adaptor;

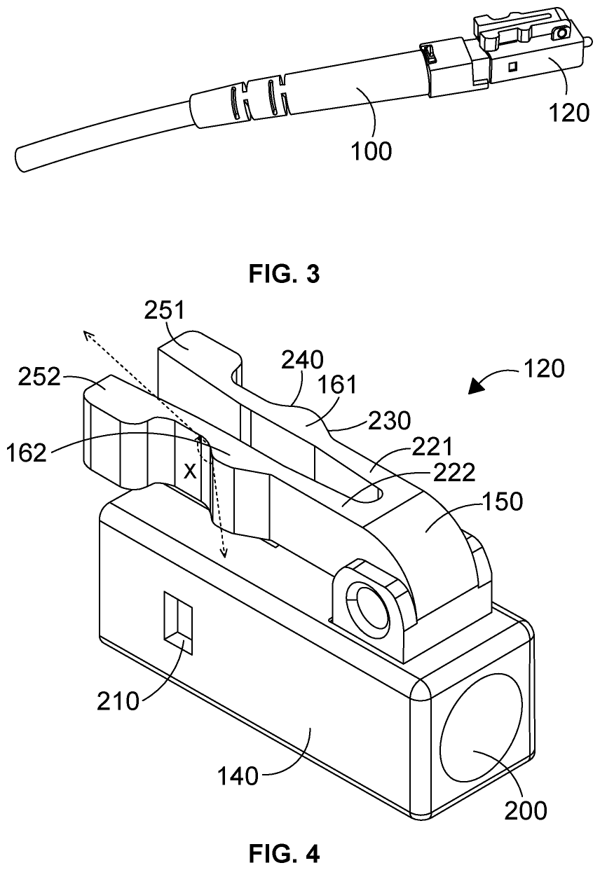

FIG. 3 depicts a perspective view of the fibre optic connector in accordance with the present claimed invention engaged with optical fibres;

FIG. 4 depicts a perspective view of the fibre optic connector of FIG. 3;

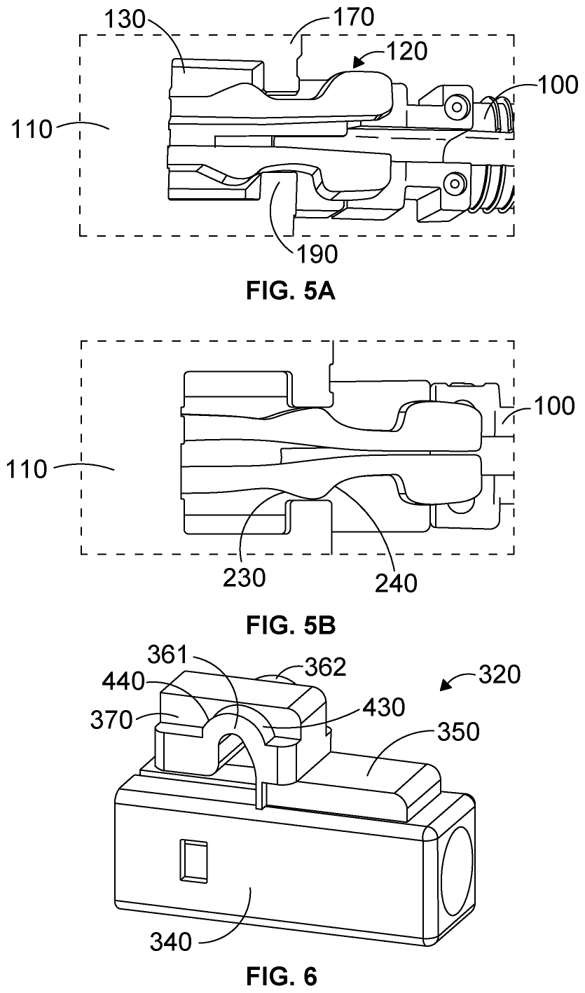

FIG. 5a depicts a view of the fibre optic connector of FIG. 3 inserted into a fibre optic adaptor;

FIG. 5b depicts a view of a fibre optic connector of FIG. 3 partially disengaged from a fibre optic adaptor; and

FIG. 6 depicts a perspective view of an alternative embodiment of the fibre optic connector.

With reference to FIGS. 1 and 2, there is illustrated a portion of a typical fibre optic adaptor 10 into which a typical simplex fibre optic connector 20 is inserted. The fibre optic adaptor 10, comprises two sockets 31, 32. The typical connector 20 is suitable for insertion into either of the two sockets 31, 32. The typical connector 20 engages with a single socket 30, 31 in use. The typical connector 20 comprises a body 40 and a latch mechanism 50 for releasably retaining the typical connector 20 in the fibre optic adaptor 10. The latch mechanism 50 comprises two engagement elements 61, 62. The latch mechanism 50 is sprung or resiliently biased away from the body 40 in a vertical direction. The fibre optic adaptor 10 further comprises a front top surface 70, comprising four standard latch keyways or retention cavities 80, and at least one retention shoulder 90.

The latch mechanism 50 of the typical connector 20 of FIG. 1 operates in the vertical plane and the latch mechanism 50 is configured for actuation in a direction vertically up the body 40 of the typical fibre optic connector 20. In use, the typical fibre optic connector 20 is guided and urged towards the fibre optic adaptor 10, usually by a user during installation or maintenance. The latch mechanism 50 contacts the front top surface 70 of the fibre optic adaptor 10. As the typical connector 20 is pushed further into the adaptor 10, the engagement elements 61, 62 slide along inside the socket 31. On reaching the retention cavity 80 the biased nature of the latch mechanism 50 is such that the engagement element 61 moves out of the socket 31 and springs upward into the retention cavity 80 to create a temporary latch. The engagement element 61 engages with the retention cavity 80 and bear against retention shoulders 90, to effect the latch that holds the typical connector 20 and the adaptor 10 together. The retention shoulders 90 are formed as part of an indent or recess in a socket 31, 32 or keyway within the adaptor 10.

The vertical movement of the latch arm 16 in a downward direction will release and remove the engagement elements 61, 62 from the retention cavities 80, thereby unlatching the body 40 of the typical connector 20 and so allowing the withdrawal of the typical connector 20 from the adaptor 10.

Although the above connection is described for a simplex connector and adaptor a similar arrangement and structure has been used for a duplex connector mated with an adaptor with a double latch.

Turning now to FIGS. 3 and 4 the latch mechanism of the present invention, in the following description similar numerals will be used for similar parts of an embodiment of the present invention comprising a horizontal latch and the typical connector 20 as described above for a vertical latch. Similar numerals are also used in the description of a further embodiment of the present invention shown in FIG. 6.

FIG. 3 shows an embodiment of the present claimed invention in use, wherein a fibre optic cable 100 is inserted into the fibre optic connector 120. The cable 100 slots into an opening 200 of the body 140 of the connector 120. The opening 200 corresponds in size and shape to a cable 100 so as to receive and terminate the optical fibres. A cut out window 210 in both sides of the body 140 allows the cable 100 to be removably retained inside the connector 120. The end of the cable 100 extends beyond the body 140 of the connector 120 such that when the cable 100 and connector 120 assembly are inserted in an adaptor 110, the end of the cable 100 engages with the adaptor 110.

In this embodiment, the connector 120 is made from a unitary piece of resiliently deformable material such as resiliently deformable plastic e.g. polylactic acid (PLA). In alternative embodiments, the connector 120 may be formed by more than one element assembled together. Alternative materials with differing properties may be used for each element of the connector 120.

The latch mechanism 150 is provided on the top side of the body 140. The latch mechanism 150 comprises a pair of resiliently deformable latch members 221, 222. The resiliently deformable latch members 221, 222 extend from the same point within the latch mechanism 150 and extend beyond the edge of the body 140, parallel to the longitudinal axis of the connector 120. The latch members 221, 222 are mirror images of each other along the longitudinal centre-line of the body 140 and are shaped to extend slightly away from one another, forming a V shape on the body 140. In this way, the latch members 221, 222 are resiliently biased away from one another. The latch members 221, 222 are offset from the body 140 of the connector 120, such that there is a gap between the top surface of the body 140 and the underside of the latch members 221, 222.

Each latch member 221, 222 comprises an engagement element 161, 162 which protrudes from the side of each latch member 221, 222 in a direction perpendicular to the longitudinal axis of the body 140. Each engagement element 161, 162 protrudes away from the opposing latch member 221, 222. The length of each latch member 221, 222 is such that each engagement element 161, 162 protrudes from an approximately central position on each latch member 221, 222.

Each engagement element 161, 162 comprises a leading surface 230 and a trailing surface 240, the leading surface 230 extending from the side surface of the latch member 221, 222 into the trailing surface 240 which then re-joins with the side surface of the latch member 221, 222. As such the overall protruding surface of the engagement element 161, 162 transitions smoothly from and back to the side surface of the latch member 221, 222. However, abrupt transitions are also envisaged, and may be desirable.

The leading surface 230 and trailing surface 240 both comprise a convex curve. In this embodiment, the leading surface 240 meets the trailing surface 250 at an angle smaller than the angle at which the trailing surface 240 leaves the leading surface 230. The trailing surface 240 leaves the latch member 221, 222 at an obtuse angle (X). In this way, the trailing surface 240 is not at a right angle to the latch member 221, 222.

In alternative embodiments, the leading surface 230 and trailing surface 240 are mirror images of each other along the centreline of the engagement element 161, 162, perpendicular to the longitudinal axis of the latch member 221, 222.

The latch mechanism 150 of FIGS. 3 and 4 operates in the horizontal plane and is configured for actuation in a direction laterally across the body 140 of the fibre optic connector 120.

The resiliently deformable latch members 121, 122 are capable of flexing towards each other under the action of lateral force. Each latch member 121, 122 features a release portion 251, 252 at which a user can apply pressure laterally across the body 140. These release portions 251, 252 are at the end of each latch member 121, 122. These release portions 251, 252 may comprise textured grooves or raises to assist in user grip of the release portions 251, 252.

FIGS. 5a and 5b show the connector 120 engaging with a typical fibre optic adaptor 110 with full insertion of the connector 120 into the adaptor 110 shown in FIG. 5a and part insertion shown in FIG. 5b.

The typical adaptor 110 comprises a socket 130 with a pair of retention shoulders 190 on either side of the socket 130 entrance. The retention shoulders 190 protrude towards each other, such that the entrance of the socket 130 is narrower than the width of the socket cavity. As shown in FIG. 5a, the engagement elements 161, 162 protrude from the latch members 221, 222 such a distance that in the bias position of the latch mechanism 150, the engagement elements 161, 162 extend past the retention shoulders 190 into the socket 130.

In use, the connector 120 will be guided and urged towards the adaptor 110, usually by a user during installation or maintenance. The leading surface 230 of the engagement element 161, 162 of the latch member 221, 222 contacts the front top surface of the adaptor 170. The engaging element 161, 162 contacts the retention shoulder 190 such that as the connector 120 is pushed into the socket 130, the retention shoulder 190 resists the motion of the connector 120. The retention shoulder 190 forces the latch member 221, 222 to flex inwards towards the opposing latch member 221, 222 such that the leading surface 230 is guided over the retention shoulder 190.

The curved nature of the leading surface 230 means that the latch mechanism 150 is smoothly actuated as the connector 120 is guided into the adaptor 110. The retention shoulder 190 transitions smoothly from the leading surface 230 as it meets the trailing surface 240. At the position where the retention shoulder 190 is in contact with the meeting point of the leading surface 230 and the trailing surface 240, as shown in FIG. 5b, the latch mechanism 150 is fully actuated and the end of the pair of latch members 221, 222 meet.

As the connector 120 is pushed further into the adaptor 110, the force actuating the latch mechanism 150 gradually reduces as the retention shoulder 190 follows the curved path of the trailing surface 240 such that the latch members 221, 222 return to their bias position. The resiliently deformable nature of the latch members 221, 222 allow for the return of the latch members 221, 222 to their bias position. This forms a temporary latch between the engagement element 161, 162 and the retention shoulder 190, such that the connector 120 and the adaptor 110 are held together. A portion of the trailing surface 240 bears against the retention shoulder 190 such that some resistance to disengagement is provided when the connector 120 is subject to a force in a direction parallel to the longitudinal axis of the connector 120. FIG. 5a shows the connector 120 latched onto the adaptor 110.

The release and unlatch action lateral movement of the latch member 221, 222 in an inward direction toward the opposing latch member 221, 222 will release and remove the engagement element 161, 162 from its position against the retention shoulder 190, thereby unlatching the connector body 140 from the adaptor 110 and so allowing the withdrawal of the connector 120 from the adaptor 110. The nature of the latch mechanism 150 being a mirror image along the longitudinal axis of the connector 120. Alternatively, the latch mechanism 150 is not a mirror image along the longitudinal axis of the connector 120, and the engagement elements 161, 162 are mirror images of each other along the longitudinal axis of the connector 120.

Additionally, a force applied in a direction parallel to the longitudinal axis of the connector 120 will also allow unlatching and withdrawal of the connector 120 from the adaptor 110. This unlatching occurs without the need for user actuation of the latch mechanism 150. A force of 20N or above will overcome the resilient bias of the latch mechanism 150 and remove the connector 120 from the adaptor 110. A force of 20N or above will force the trailing surface 240 against the retention shoulder 190 with enough force to guide the retention shoulder 190 over the engagement element 161, 162 and draw together the latch members 221, 222 thus actuating the latch mechanism 150 without the need for user actuation.

In this way, the risk of permanent deformation or failure of the connector 120 or cable 100 when large forces act upon the connector, such as accidental forces, is greatly reduced. The connector 120 is removed from the adaptor 110 at 20N and as such the connector 120 will not experience the full force against the retention shoulders 190 of the socket 130.

A force below 20N will not be adequate to guide the retention shoulders 190 over the trailing surface 240 such that the latch members 161, 162 are drawn together and the connector 120 is unlatched and removed from the adaptor 110. As such, small forces pulling on the connector 120 or cable 100 will not remove the connector 120 from the adaptor 110. The connector 120 is removably retained in the socket 130 under no external force and under small forces (less than 20N).

FIG. 6 shows an alternative embodiment of the present invention comprising a vertical latch replacing the horizontal latch of FIGS. 3 to 5b. In alternative embodiments of the present invention, both a horizontal and vertical latch may be present on the connector.

In this embodiment, engagement elements 361, 362 protrude from the top surface of a latch member 370. In alternative embodiments, this may be a pair of latch members 370. In this way, actuation of the latch mechanism 350 occurs towards the body 340 of the connector 320. As such, the latch member 370 is offset from the surface of the connector body 340 and is bias such that the latch member 370 sits parallel to the longitudinal axis of the connector 320.

The surface of the engagement elements 361, 362 form a smooth curve wherein the leading surface 430 and trailing surface 440 are substantially mirror images of each other. The two angles which the curve follows either side of the meeting point of the leading surface 430 and the trailing surface 440 are acute and equal.

The engaging elements 361, 362 of the latch member 370 contact the top front surface 170 of the of the adaptor such that the top front surface 170 is guided over the leading surface 430 of the connector 320 when the connector 320 is guided into the adaptor 110. This causes actuation of the latch mechanism 350 towards the body 340 of the connector 320 as the top front surface 170 forces the latch member 370 downwards.

Latching occurs as in the embodiment described in FIGS. 3 to 5a with the engagement elements 361, 362 latching into the retention cavities 80 of the top front surface 170 of the adaptor 110 instead of the engagement elements 361, 362 interacting with the retention shoulders 190 of the adaptor 110. The trailing surface 440 of the engagement elements 361, 362 contacts the retention cavities 80 of the adaptor such that the connector 320 is removably retained in the socket 130.

A force of 20N is required to remove the connector 320 out of the adaptor 110. With a 20N force, the trailing surface 440 is guided along the edge of the retention cavity 80 such that the latch member 370 is flexed towards the connector body 340 under the force and the latch is actuated without direct user actuation.

Further embodiments within the scope of the present invention may be envisaged that have not been described above, for example, there may be different shapes of engagement element and different placement of the latch mechanism. There may be a number of latch members and engagement elements, and the location, orientation and contact ‘latching’ points of these can be varied. The latch members and the latch member components may be of any one of a variety of shapes; curved, tapered, blocked. Additionally, the engagement elements may be spherical caps. Other material combinations may be envisaged. One or more connectors may be utilised and different connectors may be envisaged. The invention is not limited to the specific examples or structures illustrated, a greater number of components than are illustrated in the figures could be used, for example.

1. A fibre optic connector for insertion to a fibre optic adaptor, said fibre optic connector comprising:
a body portion; and
a latch mechanism provided on the body;
said latch mechanism comprising at least one resiliently deformable latch member;
said at least one resiliently deformable latch member comprising at least one engagement element;
said at least one engagement element comprising a leading surface and a trailing surface; wherein
the angle between said trailing surface and said at least one resiliently deformable latch member is obtuse.

2. The fibre optic connector as claimed in claim 1, wherein said at least one resiliently deformable latch member is configured to resiliently deform in a direction perpendicular to the longitudinal axis of said fibre optic connector.

3. A fibre optic connector as claimed in any one proceeding claim, wherein said latch mechanism comprises two resiliently deformable latch members.

4. The fibre optic connector of claim 3, wherein said resiliently deformable latch members are mirror images of one another.

5. The fibre optic connector of claim 3 or claim 4, wherein said resiliently deformable latch members are mounted substantially opposite one another.

6. The fibre optic connector of any one of claims 3 to 5, wherein said resiliently deformable latch members are configured to deform towards each other in use.

7. The fibre optic connector of any one of claims 3 to 6, wherein said resiliently deformable latch members are resiliently biased away from one another.

8. The fibre optic connector of any one of claims 1 to 6, wherein said at least one resiliently deformable member is resiliently biased in a direction away from said body portion.

9. The fibre optic connector of claim 7 or claim 8, wherein, in use, a removal force of around 20N is required to overcome said resilient bias to remove said fibre optic connector from a fibre optic adaptor.

10. The fibre optic connector of any one preceding claim, wherein said trailing surface comprises a curve, more preferably a convex curve.

11. The fibre optic connector of any one preceding claim, wherein said leading surface comprises a curve.

12. The fibre optic connector of claim 11, wherein said leading surface comprises a convex curve.

13. The fibre optic connector of claim 11 or claim 12, wherein said leading surface and said trailing surface are substantially mirror images of one another.

14. The fibre optic connector of claim 13, wherein said engagement element comprises a spherical cap.

15. The fibre optic connector of any one preceding claim, wherein said resiliently deformable latch member transitions smoothly into said engagement element.

16. The fibre optic connector of claim 15, wherein said resiliently deformable latch member transitions smoothly into said leading surface.

17. The fibre optic connector of claim 15 or 16, wherein said resiliently deformable latch member transitions smoothly into said trailing surface.

18. The fibre optic connector of any one preceding claim, wherein said at least one resiliently deformable latch member is configured to resiliently deform towards said body portion.

19. The fibre optic connector of any one of claims 1 to 17, wherein said at least one resiliently deformable latch member is configured to resiliently deform in a direction parallel to a surface of said body portion.

20. The fibre optic connector of any one preceding claim, wherein said at least one resiliently deformable latch member comprises a release portion.

21. The fibre optic connector of claim 20, wherein said release portion is located at the end of said resiliently deformable latch member distal from said body portion.

22. The fibre optic connector of any one proceeding claim, wherein said at least one resiliently deformable latch member protrudes beyond an edge of said body portion.

23. The fibre optic connector of any one preceding claim, wherein said fibre optic connector comprises at least two latch mechanisms, said latch mechanisms provided on opposing faces of said body portion.

24. The fibre optic connector or any one preceding claim, wherein the number of said at least one resiliently deformable latch members and the number of said engagement elements is equal.

25. A kit of parts comprising a fibre optic adaptor and the fibre optic connector of any one preceding claim.
